(19) United States
(12) Patent Application Publication
(10) Pub. No.: US 2008/0245323 A1
(43) Pub. Date: Oct. 9, 2008

(54) Pump System for Supplying Pressurized Hydraulic Fluid to a Hydraulically Activated Valvetrain

(75) Inventors: Matthew Williamson, Richmond Hill (CA); Adrian C. Cioc, Ajax (CA)

Correspondence Address: MAGNA INTERNATIONAL, INC., 337 MAGNA DRIVE, AURORA, ON, L4G-7K1, CA

(73) Assignee: Magna Powertrain Inc., Concord (CA)

(21) Appl. No.: 12/088,728

(22) PCT Filed: Oct. 13, 2006
(86) PCT No.: PCT/CA2006/001668

§ 371 Date: Mar. 31, 2008

Related U.S. Application Data
(60) Provisional application No. 60/727,198, filed on Oct. 14, 2005.

(51) Int. Cl. F01L 9/02; F02B 39/04; F02B 39/10

(52) U.S. Cl. 123/90.12; 417/364; 417/410.1

(57) ABSTRACT

A pump system for supplying pressurized hydraulic fluid to a hydraulic valve actuation system for operating engine valves of an internal combustion engine comprises a conventional pump, driven by the engine, which supplies the necessary volume of pressurized hydraulic fluid when the engine is running. The system further comprises a booster pump which is driven by the starter motor of the engine and which supplies the necessary volume of hydraulic fluid during starting/cranking of the engine. The conventional pump is preferably designed and constructed for operating efficiency during engine operating conditions while the booster pump is preferably designed and constructed for operating efficiency during cranking/starting of the engine.

### FIELD OF THE INVENTION

The present invention relates to a pump system for providing pressurized hydraulic fluid to operate engine valves in an internal combustion engine. More specifically, the present invention relates to a pump system for providing such hydraulic fluid during start up and operation of the engine.

### BACKGROUND OF THE INVENTION

Much development work is underway to produce valvetrains for internal combustion engines which are more controllable than conventional cam-operated valvetrains. For operating efficiency and emission issues, it is desirable to be able to alter valve timing, opening duration and opening amount for internal combustion engines more than has been possible with cam-based systems.

Accordingly, valves operated by hydraulic actuators, under electric control, have been proposed and are well known. In such systems, hydraulic fluid is applied to an actuator piston through an electrically controlled valve to move the engine valve to an open position and a conventional valve return spring returns the engine valve to the closed position when hydraulic fluid is returned, thorough the control valve, from the actuator piston.

While such systems show great promise of improvements to engine efficiencies and reduced emissions, their design and implementation involves a variety of challenges. In particular, the pump required to provide the necessary pressurized hydraulic fluid to the actuator pistons of the valve train must be reasonably efficient and yet must be capable of providing the necessary volume of relatively high pressure (approximately 1000 to 3000 PSI or more) hydraulic fluid required to operate the valve train over a wide range of engine operating speeds and conditions.

To date, it has proven difficult to provide an adequate supply of pressurized hydraulic fluid over the range of engine operating speeds from start up of the engine to high speed operating conditions.

### SUMMARY OF THE INVENTION

It is an object of the present invention to provide a novel pump system for supplying pressurized hydraulic fluid to a hydraulic operated valvetrain which obviates or mitigates at least one disadvantage of the prior art.

According to a first aspect of the present invention, there is provided a pump system for supplying pressurized hydraulic fluid to a hydraulic valve actuation system for operating engine valves of an internal combustion engine, comprising: a pump driven by the internal combustion engine, the pump operable to receive hydraulic fluid from a reservoir and to pressurize the fluid and supply the pressurized fluid to the hydraulic valve actuation system during operation of the engine; and a booster pump driven by an electric starter motor which is operable to crank the engine during start up of the engine, the booster pump being operable to receive hydraulic fluid from the reservoir and to pressurize the fluid and supply the pressurized fluid to the hydraulic valve actuation system during start up of the engine.

The present invention provides a pump system for supplying pressurized hydraulic fluid to a hydraulic valve actuation system of an internal combustion engine. The system comprises a conventional pump, driven by the engine, which supplies the necessary volume of pressurized hydraulic fluid when the engine is running. The system further comprises a booster pump, which is driven by the starter motor of the engine, and which supplies the necessary volume of hydraulic fluid during starting/cranking of the engine. The conventional pump is preferably designed and constructed for operating efficiency during engine operating conditions while the booster pump is preferably designed and constructed for operating efficiency during cranking/starting of the engine.

### BRIEF DESCRIPTION OF THE DRAWINGS

Preferred embodiments of the present invention will now be described, by way of example only, with reference to the attached Figures, wherein:

FIG. 1 shows a schematic representation of a prior art hydraulically operated valve train; and

FIG. 2 shows a schematic representation of a pump system in accordance with the present invention.

### DETAILED DESCRIPTION OF THE INVENTION

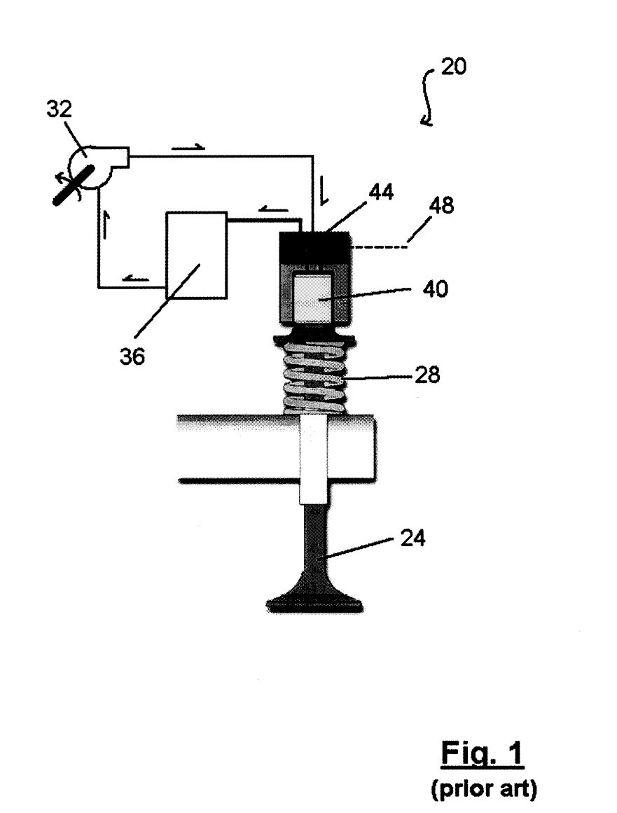

For clarity, before discussing the specifics of the present invention, a prior art hydraulically operated valvetrain system will be discussed, with reference to FIG. 1. The prior art valvetrain system is indicated generally at 20 in FIG. 1 and comprises a conventional engine valve 24 and valve return spring 28.

System 20 further comprises a pump 32 for supplying pressurized hydraulic fluid from a reservoir 36 to a hydraulic actuating piston 40, through a control valve 44. When an appropriate control signal 48 is supplied to control valve 44, control valve 44 allows pressurized fluid from pump 32 to act against actuating piston 40, opening valve 24. When another appropriate control signal 48 is supplied to control valve 44, it blocks the supply of pressurized fluid to actuating piston 40 and allows hydraulic fluid to return to reservoir 36, thus allowing return spring 28 to return valve 24 to the closed position.

For efficiency and reliability reasons, amongst others, it is contemplated that pump 32 will be mechanically driven from the engine of which valvetrain system 20 is part. Thus, pump 32 need be able to provide sufficient volume of pressurized hydraulic fluid over the entire expected operating speed range of the engine, from starting/cranking speeds of from about 250 RPM to maximum operating speeds of, depending upon the engine, about 5000 RPM or more. In the past, it has proven to be difficult to design pump 32 to meet such requirements in a reliable, efficient and cost effective manner.

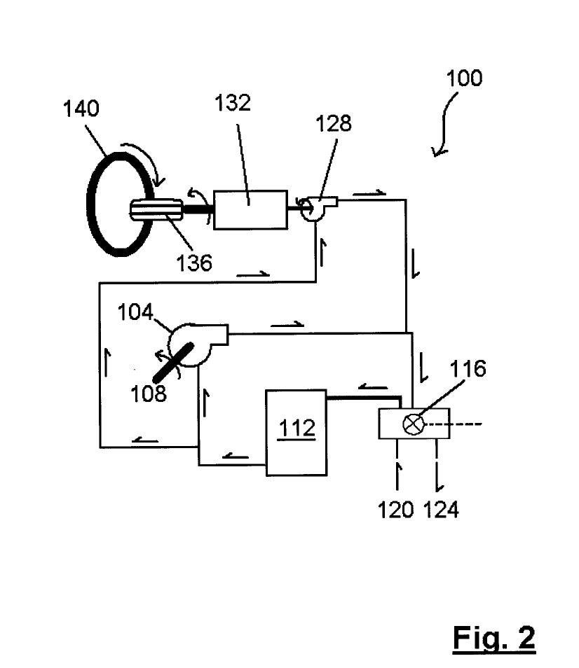

FIG. 2 shows a pump system 100 for supplying pressurized hydraulic fluid to a hydraulically operated valve train system for an engine, in accordance with the present invention. Pump system 100 includes a conventional pump 104 for supplying pressurized hydraulic fluid (which can be engine oil or specific purpose hydraulic fluid) for operation of a valve train. Pump 104 is typically driven directly from the engine (not shown), via a drive shaft, gear train or other energy source 108.

Pump 104 is supplied with low pressure hydraulic fluid from a reservoir 112, which can be a tank, the oil sump of the engine, etc., and pressurizes the fluid and supplies it to electrically operated control valves 116 which control the admission of the pressurized hydraulic fluid to 120 and from 124 actuating pistons (not shown) for the engine valves (also not shown).

Pump 104 is designed to provide the necessary supply of pressurized hydraulic fluid when the engine is operating, but is not intended to provide the necessary supply of hydraulic fluid during cranking/starting of the engine, although it may contribute a portion of the necessary supply.

Instead, system 100 includes a booster pump 128 to provide the necessary supply of pressurized hydraulic fluid during starting of the engine. Specifically, booster pump 128 is driven by the starter motor 132 which is used to rotate the engine, that system 100 is installed on, to start the engine.

In the illustrated embodiment, starter motor 132 is a substantially conventional DC starter motor which rotates the engine via the engagement of a pinion gear 136, on one end of the drive shaft of starter motor 132, with a ring gear 140 on the flywheel of the engine. With such conventional DC starter motors, starter motor 132 rotates at a relatively high speed to drive pinion gear 136 and ring gear 140 is rotated at a correspondingly lower speed (typically two hundred to three hundred and fifty RPM) due to the ratio between pinion gear 136 and ring gear 140

In the illustrated embodiment, booster pump 128 is driven by the other end of the drive shaft of starter motor 132, although it is also contemplated that any suitable form of mechanical connection of the input shaft of booster pump 128 to starter motor 132 can be employed, such as a gear train, etc.

As booster pump 128 is only intended to provide a supply of pressurized hydraulic fluid during start up of the engine, it is designed and sized to efficiently provide the expected maximum required volume of hydraulic fluid at the necessary pressure. It is contemplated that booster pump 128 can be a fixed displacement gear pump, a gerotor pump, or the like. When booster pump 128 is operating, pressurized fluid from booster pump 132 is supplied to control valves 116 to operate the valves of the engine.

As booster pump 128 is driven by starter motor 132, no additional control circuitry or devices need be employed as starter motor 132 is already connected to suitable controls and/or solenoids such that it is only activated during starting/cranking of the engine. Once the engine has started, and starter motor 132 is deactivated, booster pump 128 no longer operates to supply pressurized hydraulic fluid and pump 108 operates instead to supply the needs of the engine valvetrain system.

By removing the need for pump 108 to supply pressurized hydraulic fluid during cranking/starting of the engine (which occurs at relatively low engine rotation speeds) the design and construction of pump 108 can be better optimized for its normal operating requirements. Similarly, as booster pump 128 need only operate at the relatively high speed of starter motor 132, during cranking/starting of the engine, the design and construction of booster pump 128 can also be better optimized for its normal operating requirements.

The present invention provides a pump system for supplying pressurized hydraulic fluid to operate a hydraulic valve train of an internal combustion engine. The system comprises a conventional pump, driven by the engine, which supplies the necessary volume of pressurized hydraulic fluid when the engine is running. The system further comprises a booster pump which is driven by the starter motor of the engine and which supplies the necessary volume of hydraulic fluid during starting/cranking of the engine. The conventional pump is preferably designed and constructed for operating efficiency during engine operating conditions while the booster pump is preferably designed and constructed for operating efficiency during cranking/starting of the engine.

The above-described embodiments of the invention are intended to be examples of the present invention and alterations and modifications may be effected thereto, by those of skill in the art, without departing from the scope of the invention which is defined solely by the claims appended hereto.

We claim:

1. A pump system for supplying pressurized hydraulic fluid to a hydraulic valve actuation system for operating engine valves of an internal combustion engine, comprising:
a pump driven by the internal combustion engine, the pump operable to receive hydraulic fluid from a reservoir and to pressurize the fluid and supply the pressurized fluid to the hydraulic valve actuation system during operation of the engine; and
a booster pump driven by an electric starter motor which is operable to crank the engine during start up of the engine, the booster pump being operable to receive hydraulic fluid from the reservoir and to pressurize the fluid and supply the pressurized fluid to the hydraulic valve actuation system during start up of the engine.

2. The pump system of claim 1 wherein the hydraulic fluid is engine lubricating oil.

3. The pump system of claim 2 wherein the reservoir is the sump of the engine.

4. The pump system of claim 1 wherein the hydraulic fluid has a lower viscosity than the engine lubricating oil.

5. The pump system of claim 1 wherein the electric starter motor is a DC motor.

6. An internal combustion engine having a hydraulic valve actuation system for operating the engine inlet and outlet valves, the engine comprising:
a pump driven by the internal combustion engine, the pump operable to receive hydraulic fluid from a reservoir and to pressurize the fluid and supply the pressurized fluid to the hydraulic valve actuation system during operation of the engine; and
a booster pump driven by an electric starter motor which is operable to crank the engine during start up of the engine, the booster pump being operable to receive hydraulic fluid from the reservoir and to pressurize the fluid and supply the pressurized fluid to the hydraulic valve actuation system during start up of the engine.
